(19) United States
(12) Patent Application Publication
(10) Pub. No.: US 2026/0153955 A1
(43) Pub. Date: Jun. 4, 2026

(54) SENSOR PANEL, SENSING DEVICE INCLUDING THE SAME, AND ELECTRONIC DEVICE

(71) Applicant: Samsung Display Co., Ltd., Yongin-Si (KR)

(72) Inventor: Jung Ha SON, Yongin-si (KR)

(21) Appl. No.: 19/258,057

(22) Filed: Jul. 2, 2025

(30) Foreign Application Priority Data
Dec. 4, 2024 (KR) 10-2024-0178551

(51) Int. Cl. G06F 3/041; G06F 3/044

(52) U.S. Cl. CPC G06F 3/04164; G06F 3/0446

(57) ABSTRACT

A sensing device is disclosed that includes a sensor panel. The sensor panel includes sensors arranged in a matrix form in a sensing area and sensing lines electrically connected one-to-one to the sensors. The sensing area includes a first area, a second area, and a third area between the first area and the second area. The sensing lines include (1-1)th sensing lines, (1-2)th sensing lines, (2-1)th sensing lines, and (2-2)th sensing lines. A first sensor driver is electrically connected to the sensors in the first area through the (1-1)th sensing lines. A second sensor driver electrically connected to the sensors in the second area through the (2-1)th sensing lines. The first sensor driver is electrically connected to a first subset of the sensors in the third area through the (1-2)th sensing lines. The second sensor driver is electrically connected to a second subset of the sensors in the third area through the (2-2)th sensing lines.

### CROSS-REFERENCE TO RELATED APPLICATION

This application claims priority to and the benefit of Korean Patent Application No. 10-2024-0178551 filed in the Korean Intellectual Property Office on Dec. 4, 2024, the entire contents of which are incorporated herein by reference.

### BACKGROUND

### 1. Field

Embodiments of the present disclosure relate to a sensor panel, a sensing device, and an electronic device.

### 2. Description of the Related Art

Display devices present images to users and, as display of information has increased, demands for improved display devices have increased in various ways. In addition, research and development of display devices that include a touch sensor is being conducted to improve user convenience and increase the application field.

### SUMMARY

The present disclosure provides a sensor panel, a sensing device, and an electronic device with improved touch performance.

According to an embodiment of the present disclosure, a sensing device includes a sensor panel including sensors arranged in a matrix form in a sensing area and sensing lines electrically connected one-to-one to the sensors, wherein the sensing area includes a first area, a second area, and a third area between the first area and the second area, wherein the sensing lines include (1-1)th sensing lines, (1-2)th sensing lines, (2-1)th sensing lines, and (2-2)th sensing lines; a first sensor driver electrically connected to the sensors in the first area through the (1-1)th sensing lines; and a second sensor driver electrically connected to the sensors in the second area through the (2-1)th sensing lines. The first sensor driver is electrically connected to a first subset of the sensors in the third area through the (1-2)th sensing lines. The second sensor driver is electrically connected to a second subset of the sensors in the third area through the (2-2)th sensing lines.

The first sensor driver may be electrically disconnected from the sensors in the second area, and the second sensor driver may be electrically disconnected from the sensors in the first area.

The first area and the second area may be spaced apart from each other in a first direction, the third area may include at least one sensor column, and a sensor column may include the sensors arranged along a second direction intersecting the first direction.

The third area may include two sensor columns.

The third area may include one sensor column.

The sensing device may further include a first multiplexer electrically connected between the sensors in the first area and the first sensor driver; and a second multiplexer electrically connected between the sensors in the second area and the second sensor driver. The first multiplexer and the second multiplexer may be electrically connected to the first subset of the sensors and the second subset of the sensors, respectively, in the third area.

The first multiplexer may be electrically connected to the first sensor driver through pads, the first multiplexer may selectively connect the first subset of the sensors in the third area to a pad among the pads, and the sensors in the first area may not be electrically connected to the pad.

The first multiplexer may include a first transistor electrically connected between a sensing line among the sensing lines and a first driving line; a second transistor electrically connected between the sensing line and a connection line; a third transistor electrically connected between the connection line and the pad among the pads; and a fourth transistor electrically connected between the connection line and a second driving line.

The one pad may be provided with a target pulse signal, the first driving line may be provided with a first driving signal having a phase opposite to the target pulse signal, and the second driving line may be provided with a second driving signal having a same phase as the target pulse signal.

The first sensor driver and the second sensor driver may obtain one sensing signal for each of the sensors in the first area and the second area, and obtain two sensing signals for each of the sensor in the third area.

The first sensor driver and the second sensor driver may sense a touch input based on sensing signals received from the sensors, and the first sensor driver and the second sensor driver may adjust touch sensitivity based on the sensing signals obtained from the sensors in the third area.

The first area and the second area may be spaced apart from each other in a first direction, each of the first sensor driver and the second sensor driver may sequentially obtain the sensing signal from the sensors along the first direction, and a time point at which the first sensor driver obtains the sensing signal for the sensors in the third area and a time point at which the second sensor driver obtains the sensing signal for the sensors in the second area may be different from each other and do not overlap each other.

According to an embodiment of the present disclosure, a sensor panel includes a sensing area including a first area, a second area, and a third area between the first area and the second area; sensors arranged in matrix form in the sensing area; sensing lines electrically connected one-to-one to the sensors, wherein the sensing lines include (1-1)th sensing lines, (1-2)th sensing lines, (2-1)th sensing lines, and (2-2)th sensing lines; a first multiplexer electrically connected to the sensors in the first area through the (1-1)th sensing lines; and a second multiplexer electrically connected to the sensors in the second area through the (2-1)th sensing lines. The first sensor driver is electrically connected to a first subset of the sensors in the third area through the (1-2)th sensing lines. The second sensor driver is electrically connected to a second subset of the sensors in the third area through the (2-2)th sensing lines.

The first multiplexer may be electrically disconnected from the sensors in the second area, and the second multiplexer may be electrically disconnected from the sensors in the first area.

The first area and the second area may be spaced apart from each other in a first direction, the third area may include at least one sensor column, and a sensor column may include the sensors arranged along a second direction intersecting the first direction.

The third area may include two sensor columns.

The third area may include one sensor column.

The first multiplexer may be electrically connected to pads, the first multiplexer may selectively connect the sensors in the third area to a pad among the pads, and the sensors in the first area may not be electrically connected to the pad.

The first multiplexer may includes a first transistor electrically connected between a sensing line among the sensing lines and a first driving line; a second transistor electrically connected between the sensing line and a connection line; a third transistor electrically connected between the connection line and the pad among the pads; and a fourth transistor electrically connected between the connection line and a second driving line.

According to an embodiment of the present disclosure, an electronic device includes one or more processors configured to provide input image data; a display device configured to display an image based on the input image data; and a power supply configured to supply power to the display device. The display device includes a display unit including a base layer and a light-emitting element disposed on the base layer; a sensing unit including sensors and sensing lines, wherein the sensors are disposed on the display unit and arranged in a matrix form in a sensing area, the sensing lines are electrically connected to the sensors one-to-one, the sensing area includes a first area, a second area, and a third area between the first area and the second area, and the sensing lines include (1-1)th sensing lines, (1-2)th sensing lines, (2-1)th sensing lines, and (2-2)th sensing lines; a first sensor driver electrically connected to the sensors in the first area through the (1-1)th sensing lines; and a second sensor driver electrically connected to the sensors in the second area through the (2-1)th sensing lines. The first sensor driver is electrically connected to a first subset of the sensors in the third area through the (1-2)th sensing lines. The second sensor driver is electrically connected to a second subset of the sensors in the third area through the (2-2)th sensing lines.

According to the embodiments of the present disclosure, in the sensor panel, the sensing device, and the electronic device, the first and second sensor drivers (or the first and second multiplexers) may share a sensor (or a sensing electrode) of a third area (or a boundary area) between the first area and the second area. Accordingly, the touch sensitivity of the first and second sensor drivers may be objectively adjusted based on the sensing value obtained in the third area, and the touch performance for the third area may be improved.

Effects of embodiments of the present disclosure are not limited by what is explained or illustrated above, and more various effects and features of the present disclosure will be described in detail in the following.

### BRIEF DESCRIPTION OF THE DRAWINGS

FIG. 1 is a schematic diagram illustrating a display device according to embodiments.

FIG. 2 is a schematic plan view illustrating an embodiment of a display unit included in the display device of FIG. 1.

FIG. 3 is a schematic plan view illustrating an embodiment of a sensing unit included in the display device of FIG. 1.

FIG. 4 is a schematic cross-sectional view illustrating the display device of FIG. 1.

FIGS. 5 and 6 are schematic plan views illustrating a sensing device according to embodiments.

FIGS. 7 and 8 are schematic diagrams for describing an operation of sensing a touch input by the sensing device of FIG. 5.

FIG. 9 is a schematic plan view illustrating an embodiment of the sensing device of FIGS. 5 and 6.

FIG. 10 is a schematic circuit diagram illustrating an embodiment of a sub-multiplexer included in the sensing device of FIG. 9.

FIG. 11 is a plan view illustrating an operation of a sensing device.

FIG. 12 is a waveform diagram illustrating an embodiment of a signal applied to the sensing electrode of FIG. 11.

FIG. 13 is a schematic plan view illustrating a sensing device according to a comparative example.

FIG. 14 is a diagram illustrating an embodiment of a sensing signal acquired by the sensing device of FIG. 13 and a sensing signal acquired from the sensing device of FIG. 5.

FIG. 15 is a waveform diagram illustrating an embodiment of a sensing signal acquired by the sensing device of FIG. 5.

FIG. 16 is a schematic plan view illustrating a sensing device according to embodiments.

FIG. 17 is a schematic block diagram illustrating an electronic device according to embodiments.

FIG. 18 is a schematic diagram illustrating an example in which the electronic device of FIG. 17 is implemented as a smartphone.

FIG. 19 is a schematic diagram illustrating an example in which the electronic device of FIG. 17 is implemented as a tablet PC.

FIG. 20 is a schematic diagram illustrating an example in which the electronic device of FIG. 17 is implemented as a smart watch.

FIG. 21 is a schematic diagram illustrating an example in which the electronic device of FIG. 17 is implemented as an automobile display system.

### DETAILED DESCRIPTION OF THE EMBODIMENTS

The present disclosure may be modified in various ways and have multiple forms and embodiments will be illustrated and described in detail in the following. However, this is not intended to limit the present disclosure to any particular disclosed forms, and it is to be understood to include all modifications, equivalents, and alternatives that fall within the spirit and scope of the present disclosure.

Terms such as first, second, and the like will be used only to describe various elements, and are not to be interpreted as limiting these elements. These terms are only used to differentiate one element from another. For example, a first element may be referred to as a second element, and similarly, a second element may be referred to as a first element, without departing from the scope of the present disclosure. Singular forms are intended to include plural forms unless the context clearly indicates otherwise.

As used herein, the word “or” means logical “or” so that, unless the context indicates otherwise, the expression “A, B, or C” means “A and B and C,” “A and B but not C,” “A and C but not B,” “B and C but not A,” “A but not B and not C,” “B but not A and not C,” and “C but not A and not B.”

Some embodiments are described in the accompanying drawings in relation to functional blocks, units, or modules. Those skilled in the art will understand that these blocks, units, or modules are physically implemented by logic circuits, discrete components, microprocessors, hard-wired circuits, memory elements, wire connections, or other electronic circuits. These may be formed by using semiconductor-based manufacturing techniques or other manufacturing techniques. In the case of the blocks, units, or modules being implemented by microprocessors or other similar hardware, they may be programmed and controlled by using software to perform various functions discussed herein and may optionally be driven by firmware or software. It is also contemplated that each block, unit, or module may be implemented by dedicated hardware, or as a combination of dedicated hardware to perform some functions and a processor (for example, one or more programmed microprocessors and associated circuit) to perform other functions. In addition, each block, unit, or module of some embodiments may be physically separated into two or more interacting and discrete blocks, units, or modules without departing from the inventive concepts. Further, the blocks, units, or modules of some embodiments may be physically combined into more complex blocks, units, or modules without departing from the inventive concepts.

In the present disclosure, it should be understood that the terms “include”, “comprise”, “have”, and “configure” indicate that a feature, a number, a step, an operation, an element, a part, or a combination thereof described in the specification is present, but does not exclude a possibility of presence or addition of one or more other features, numbers, steps, operations, elements, parts, or combinations. In addition, when a portion of a layer, a film, a area, a plate, or the like is “on” another portion, this includes not only the case where the other portion is “directly on” but also the case where there is another portion in the middle thereof. In addition, in the present specification, when a portion such as a layer, a film, a area, or a plate is formed on another portion, the formed direction is not limited to an upper direction, and includes a side surface or a lower direction. Conversely, when a portion of a layer, a film, a area, a plate, or the like is “below” another portion, this includes not only the case where the other portion is “directly below” but also the case where there is another portion in the middle.

In the figures, reference characters presented and discussed with respect to a particular figure have a similar meaning when presented in other figures.

Hereinafter, a display device according to an embodiment of the present disclosure will be described with reference to drawings related to embodiments of the present disclosure.

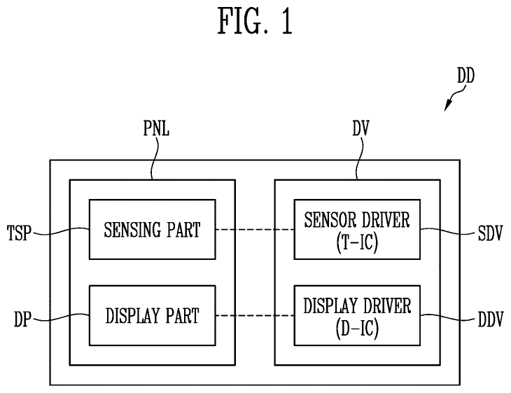

A display device DD according to embodiments will be described with reference to FIGS. 1 to 4.

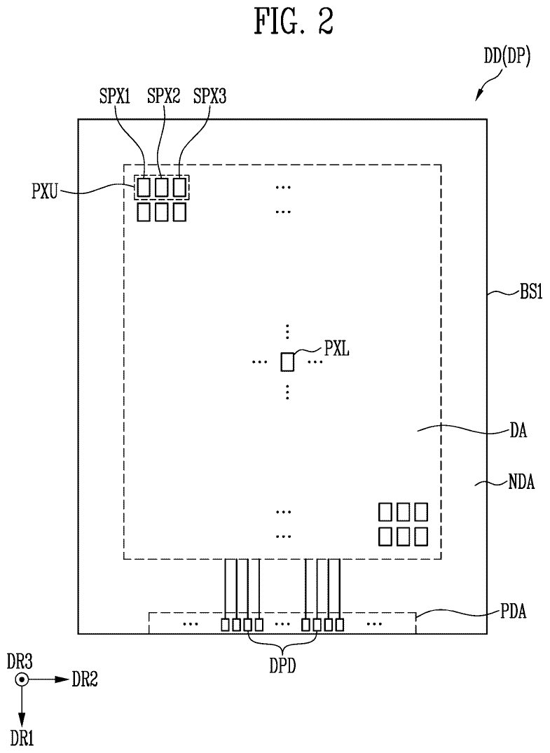

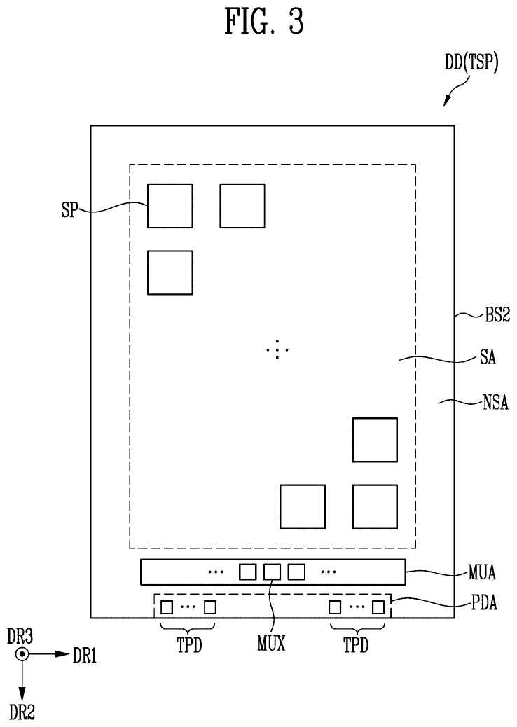

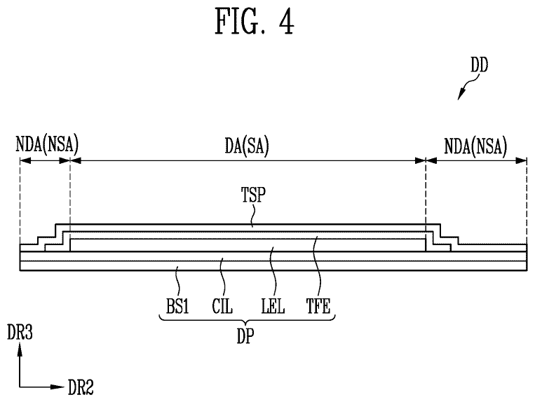

FIG. 1 is a schematic diagram illustrating a display device according to embodiments. FIG. 2 is a schematic plan view illustrating an embodiment of a display unit included in the display device of FIG. 1. FIG. 3 is a schematic plan view illustrating an embodiment of a sensing unit included in the display device of FIG. 1. FIG. 4 is a schematic cross-sectional view illustrating the display device of FIG. 1.

Referring to FIGS. 1 to 4, a display device DD is configured to provide (or emit) light. In an embodiment, the display device DD may be applied to various devices, and the applicable devices are not limited to particular examples.

The display device DD includes a panel PNL and a driving circuit DV configured to drive the panel PNL.

The panel PNL may include a display unit DP (or a display part) configured to display an image and a sensing unit TSP (or a sensing part) configured to sense a user input (e.g., a touch input).

The display unit DP may include pixels PXL. The sensing unit TSP may include sensing electrodes SP (or sensors).

The driving circuit DV may include a display driver (or D-IC) DDV configured to drive the display unit DP and a sensor driver (or T-IC) SDV configured to drive a sensing unit TSP. The sensing unit TSP and the sensor driver SDV may constitute a sensing device.

In an embodiment, the display unit DP may be referred to as a display layer or a display panel. The sensing unit TSP may be referred to as a sensing layer, a sensor panel, or a touch sensor.

The pixels PXL may display an image in units of a display frame period. The sensing electrodes SP may sense a user's input (e.g., a touch input) in units of a sensing frame period. In an embodiment, the sensing frame period and the display frame period may be independent of each other or may be different from each other. The sensing frame period and the display frame period may be synchronized or asynchronous to each other.

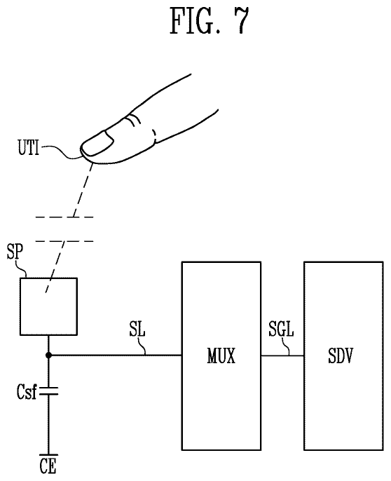

The sensing unit TSP including the sensing electrodes SP may acquire (or obtain) information on the user touch input UTI (see FIG. 7). The information on the touch input (or touch event) may mean information including a position of a touch that a user wants to provide.

A first base layer BS1 may be a base substrate or a base member for supporting the display device DD. The first base layer BS1 may be a rigid substrate including glass. Alternatively, the first base layer BS1 may be a flexible substrate. In this case, the first base layer BS1 may include an insulating material such as a polymer resin such as polyimide. However, the present disclosure is not particularly limited thereto.

The display device DD (or the display unit DP) may include a display area DA and a non-display area NDA. The non-display area NDA may surround at least a part of the display area DA. The non-display area NDA may be located on the periphery of the display area DA.

A pixel PXL and a scan line and a data line electrically connected to the pixel PXL may be disposed in the display area DA.

The pixel PXL may be configured to receive a data signal from the data line based on a scan signal of a turn-on level supplied from the scan line, and emit light of a luminance corresponding to the data signal. Accordingly, an image corresponding to the data signal is displayed in the display area DA.

The pixels PXL may be arranged according to various arrangement structures in the display area DA. For example, the pixels PXL may be arranged according to a stripe, a PENTILE™ (or normal PENTILE™), a diamond PENTILE™ array structure, or the like. However, the present disclosure is not necessarily limited to the above-described examples.

Each pixel PXL (or sub-pixel) may include two or more sub-pixels. The two or more sub-pixels may form a pixel unit PXU capable of emitting light of various colors.

For example, the pixel PXL may include a first sub-pixel SPX1, a second sub-pixel SPX2, and a third sub-pixel SPX3. Each of the first to third sub-pixels SPX1 to SPX3 may emit light of one color. For example, the first sub-pixel SPX1 may be a red pixel that emits a light in red (e.g., a first color), the second sub-pixel STX2 may be a green pixel that emits light in green (e.g., a second color), and the third sub-pixel SPX3 may be a blue pixel that emits light in blue (e.g., a third color).

As another example, the pixel PXL may include four sub-pixels. For example, the pixel PXL may be implemented as an RGBG type pixel unit PXU including one red pixel, one blue pixel, and two green pixels, or may be implemented as a RGBW type pixel unit TXU including one red pixel, one blue pixel, one green pixel, and one white pixel. The number of sub-pixels included in the pixel PXL and the color of light emitted by each of the sub-pixels are not particularly limited.

Various wirings or built-in circuits connected to the pixels PXL of the display area DA may be located in the non-display area NDA. For example, a plurality of wirings for supplying various power and control signals to the display area DA may be located in the non-display area NDA.

The sensing unit TSP may obtain information about an input provided from a user. The sensing unit TSP may be configured to recognize a touch input.

The display device DD (or the sensing unit TSP) may include a sensing area SA and a non-sensing area NSA.

In an embodiment, the sensing area SA may be located to overlap at least one area of the display area DA. For example, the sensing area SA may be set to an area corresponding to the display area DA (e.g., an area overlapping with the display area DA), and the non-sensing area NSA may be set to an area corresponding to the non-display area NDA (e.g., an area overlapping the non-display areas NDA). In this case, when a touch input or the like is provided on the display area DA, the touch input may be detected by the sensing unit TSP.

A second base layer BS2 may include one or more insulating layers. For example, an insulating layer (e.g., an inorganic insulating layer) for forming the second base layer BS2 may be disposed (e.g., directly disposed) on the display unit DP (e.g., an encapsulation layer TFE) to form a base for forming the sensing electrodes SP. However, an example for forming the second base layer BS2 is not particularly limited.

The sensing area SA is set to an area (e.g., an active area of a sensor) that can respond to a touch input. The sensing electrodes SP for sensing a touch input or the like may be located in the sensing area SA.

The sensing electrodes SP may obtain information on a user touch input using a self-capacitance method.

The sensing electrodes SP may be arranged in various structures in the sensing area SA. For example, the sensing electrodes SP may be arranged along a first direction DR1. The sensing electrodes SP may be arranged along a second direction DR2. The sensing electrodes SP may be arranged in a matrix shape defined with respect to the first direction DR1 and the second direction DR2. However, the present disclosure is not limited thereto. For example, the sensing electrodes SP may be arranged in a circular shape, an elliptical shape, or obliquely.

In an embodiment, the first direction DR1 and the second direction DR2 may be different directions. The first direction DR1 and the second direction DR2 may be orthogonal to each other. However, the present disclosure is not necessarily limited thereto. For example, the first direction DR1 and the second direction DR2 may be oblique to each other.

In an embodiment, the sensing electrodes SP may have various shapes. For example, the sensing electrodes SP may have various shapes such as a square, a triangle, a circle, an ellipse, or a mesh shape.

In an embodiment, the sensing electrodes SP may include a conductive material. For example, the sensing electrodes SP may have conductivity by including at least one of a metal material, a transparent conductive material, and various other conductive materials. For example, the sensing electrodes SP may include at least one of various metal materials including gold (Au), silver (Ag), aluminum (Al), molybdenum (Mo), chromium (Cr), titanium (Ti), nickel (Ni), neodymium (Nd), copper (Cu), platinum (Pt), and the like, or an alloy thereof. The sensing electrodes SP may include at least one of various transparent conductive materials, including silver nanowires (AgNW), indium tin oxide (ITO), indium zinc oxide (IZO), indium gallium zinc oxide (IGZO), aluminium zinc oxide (AZO), indium tin zinc oxide (ITZO), zinc oxide (ZnO), tin oxide (SnO₂), carbon nanotubes, graphene, and the like. The sensing electrodes SP may be formed of a single layer or multiple layers, and a cross-sectional structure thereof is not particularly limited.

The panel PNL may include a pad area PDA. The panel PNL may include display pads DPD and touch sensing pads TPD disposed in the pad area PDA.

The display pads DPD may be electrically connected to the pixels PXL in the display area DA through wirings. The display pads DPD may be electrically connected to a display driver DDV in the driver circuit DV. For example, an electrical signal provided by the display driver DDV may be applied to the pixels PXL through the display pads DPD.

The touch sensing pads TPD (or pads) may be electrically connected to the sensing electrodes SP through wirings and a multiplexer MUX. The touch sensing pads TPD may be electrically connected to a sensor driver SDV in the driving circuit DV. For example, an electrical signal provided by the sensor driver SDV may be applied to the sensing electrode SP through the touch sensing pads TPD.

The drive circuit DV may include a flexible circuit board. The driving circuit DV may be implemented as an integrated circuit (IC).

The driver circuit DV may include the display driver DDV and the sensor driver SDV. The driving circuit DV may be located on a rear surface of the first base layer BS1.

The display driver DDV may be electrically connected to the display unit DP and may be configured to drive the display unit DP. The display driver DDV may be located on the rear surface of the first base layer BS1, and may be electrically connected to the pixels PXL through the display pads DPD. The display driver DDV may include a data driver, a timing controller, a scan driver, and the like.

The sensor driver SDV may be electrically connected to the sensing unit TSP, and may be configured to drive the sensing unit TSP. The sensor driver SDV may be located on the rear surface of the first base layer BS1, and may be electrically connected to the sensing electrode SP through the touch sensing pad TPD.

The panel PNL (e.g., the sensing unit TSP) may include a multiplexer area MUA. The panel PNL (e.g., the sensing unit TSP) may include a multiplexer MUX located in the multiplexer area MUA.

The multiplexer area MUA may be located on one side of the sensing area SA. The multiplexer area MUA may be located between the sensing area SA and the pad area PDA. The electrical signal supplied through the touch sensing pad TPD may be applied to the sensing electrode SP via the multiplexer MUX.

Referring to FIG. 4, the display unit DP may include a circuit layer CIL, a light-emitting element layer LEL, and an encapsulation layer TFE disposed on the first base layer BS1. A third direction DR3 may be a direction perpendicular to the first direction DR1 and the second direction DR2.

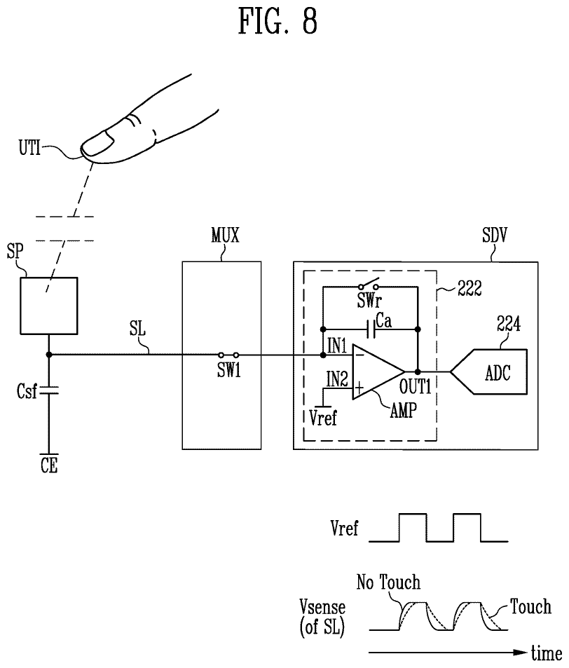

The circuit layer CIL may be disposed over the display area DA and the non-display area NDA, and may be disposed on the first base layer BS1. The circuit layer CIL is configured to drive the pixels PXL and may include a pixel circuit electrically connected to a light-emitting element. The circuit layer CIL may include mux transistors (see FIG. 8) of a multiplexer MUX.

The light-emitting element layer LEL may be disposed on the circuit layer CIL in the display area DA. The light-emitting element layer LEL may include a light-emitting element that emits light. The light-emitting element may include an organic light-emitting diode including an organic material, or may include an inorganic light-emitting diode (e.g., a micro light emitting diode (LED)) including an inorganic material. However, the present disclosure is not limited thereto.

The encapsulation layer TFE may cover the light-emitting element layer LEL. At least a portion of the encapsulation layer TFE may be located in the display area DA. The encapsulation layer TFE may encapsulate the light-emitting element layer LEL.

The sensing unit TSP may be located across the sensing area SA and the non-sensing area NSA. At least a portion of the sensing unit TSP may be disposed (e.g., directly disposed) on the encapsulation layer TFE.

In an embodiment, the sensing unit TSP may be disposed on a separately provided substrate and then formed and manufactured on the encapsulation layer TFE without being coupled to the display unit DP. Accordingly, the manufacturing process of the display device DD can be simplified.

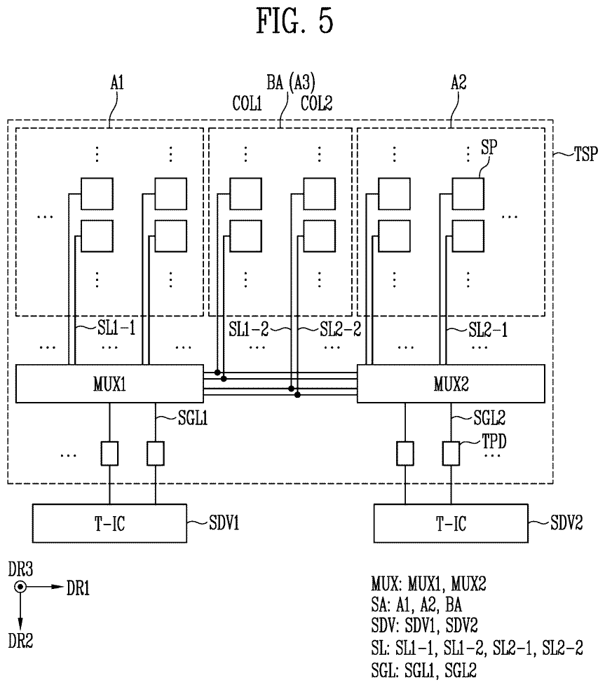

A sensing device according to an embodiment will be described with reference to FIGS. 5 to 8. For convenience of explanation, contents duplicated with the above-described contents are briefly described or not repeated.

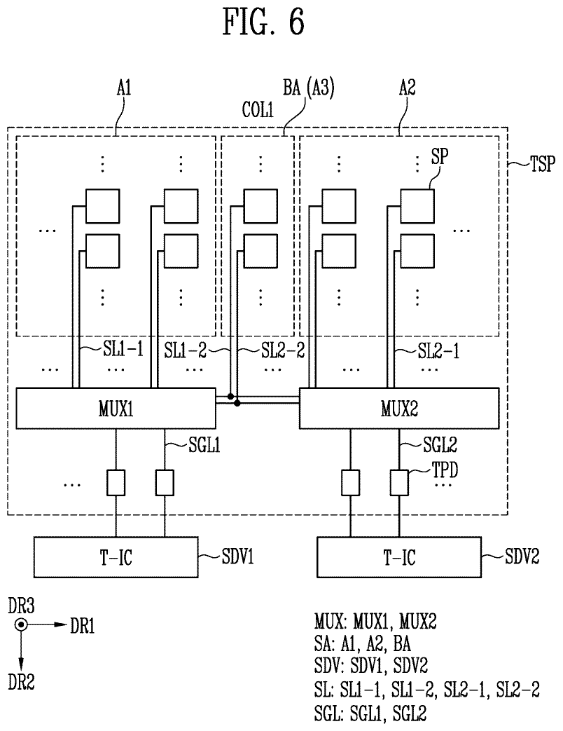

FIGS. 5 and 6 are schematic plan views illustrating a sensing device according to embodiments. FIGS. 7 and 8 are schematic diagrams for describing an operation of sensing a touch input by the sensing device of FIG. 5.

Referring to FIGS. 5 to 8, the sensing device may include the sensing unit TSP and the sensor driver SDV.

The sensing unit TSP may further include sensing lines SL (or sensor lines) and signal lines SGL. The sensing lines SL may be electrically connected to the sensing electrodes SP one-to-one. The sensing lines SL may electrically connect the sensing electrodes SP in the sensing area SA and the multiplexer MUX. The signal lines SGL electrically connects the multiplexer MUX and the touch sensing pads TPD, and may be electrically connected to the sensor driver SDV through the touch sensing pads TPD. Accordingly, driving signals provided by the sensor driver SDV may be applied to the sensing electrodes SP through the signal lines SGL, the multiplexer MUX, and the sensing lines SL.

In an embodiment, the sensing area SA may include a first area A1, a second area A2, and a boundary area BA (or a shared area, a third area A3). The first area A1 and the second area A2 may be spaced apart from each other in the first direction DR1, and the boundary area BA may be located between the first area A1 or the second area A2.

In an embodiment, the sensing lines SL may include (1-1)th sensing lines SL1-1, (1-2)th sensing lines SL1-2, (2-1)th sensing lines SL2-1, and (2-2)th sensing lines SL2-2. In an embodiment, the signal lines SGL may include first signal lines SGL1 and second signal lines SGL2.

In an embodiment, the sensor driver SDV may include a first sensor driver SDV1 and a second sensor driver SDV2. Each of the first sensor driver SDV1 and the second sensor driver SDV2 may be implemented as an integrated circuit.

The first sensor driver SDV1 may be electrically connected to the sensing electrodes SP in the first area A1 through the (1-1)th sensing lines SL1-1. In addition, the first sensor driver SDV1 may be electrically connected to a first subset of the sensing electrodes SP in the boundary area BA through the (1-2)th sensing lines SL1-2. The first sensor driver SDV1 may not be connected to or may be electrically disconnected from the sensing electrodes SP in the second area A2.

The second sensor driver SDV2 may be electrically connected to the sensing electrodes SP in the second area A2 through the (2-1)th sensing lines SL2-1. In addition, the second sensor driver SDV2 may be electrically connected to a second subset of the sensing electrodes SP in the boundary area BA through the (2-2)th sensing lines SL2-2. The second sensor driver SDV2 may not be connected to or may be electrically disconnected from the sensing electrodes SP in the first area A1.

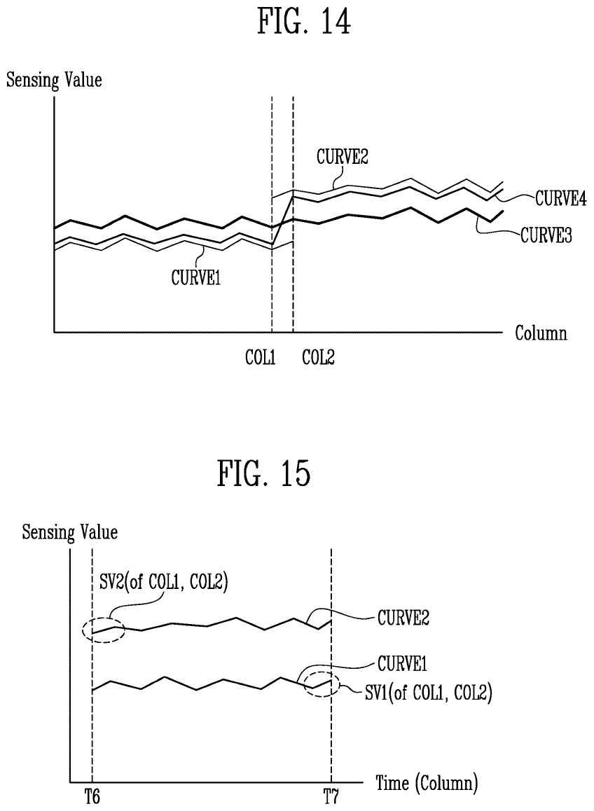

That is, the first sensor driver SDV1 and the second sensor driver SDV2 may share the sensing electrodes SP in the boundary area BA. As will be described later with reference to FIG. 14, the first sensor driver SDV1 and the second sensor driver SDV2 may adjust touch sensitivity based on sensing signals acquired from the boundary area BA. In this case, a difference in touch sensitivity between the first area A1 and the second area A2 may be reduced, and touch performance in the boundary area BA may be improved.

In an embodiment, the boundary area BA may include at least one sensor column. A sensor column may include sensor electrodes SP arranged along the second direction DR2. For example, as shown in FIG. 5, the boundary area BA may include two sensor columns, for example, a first sensor column COL1 and a second sensor column COL2. As another example, as shown in FIG. 6, the boundary area BA may include one sensor column, for example, a first sensor column COL1. However, the boundary area BA is not limited thereto, and for example, the boundary area BA may include three or more sensor columns. For reference, as the number of sensor columns included in the boundary area BA increases, data sufficient to adjust the sensitivity difference between the first area A1 and the second area A2 may be secured, but the number of channels (or the number of integrated circuits) of the sensor driver SDV may increase. In view of the above, preferably, the boundary area BA may comprise two columns.

In an embodiment, the multiplexer MUX may include a first multiplexer MUX1 and a second multiplexer MUX2.

The first multiplexer MUX1 may be electrically connected between the sensing electrodes SP in the first area A1 and the first sensor driver SDV1. In addition, the first multiplexer MUX1 may be electrically connected to the first subset of the sensing electrodes SP in the boundary area BA. The first multiplexer MUX1 may selectively connect the sensing electrodes SP (or the (1-1)th and (1-2th) sensing lines SL1-1 and SL1-2 connected to the sensing electrodes SP) in the first area A1 and the boundary area BA to the first signal lines SGL1 (or the first sensor driver SDV1 connected to the first signal lines SGL1).

The second multiplexer MUX2 may be electrically connected between the sensing electrodes SP in the second area A2 and the second sensor driver SDV2. In addition, the second multiplexer MUX2 may be electrically connected to the second subset of the sensing electrodes SP in the boundary area BA. The second multiplexer MUX2 may selectively connect the sensing electrodes SP (or the (2-1)th and (2-2)th sensing lines SL2-1 and SL2-2 connected to the sensing electrodes SP) in the second area A2 and the boundary area BA to the second signal lines SGL2 (or the second sensor driver SDV2 connected to the second signal lines SGL2).

That is, the first and second multiplexers MUX1 and MUX2 may share the sensing electrodes SP in the boundary area BA.

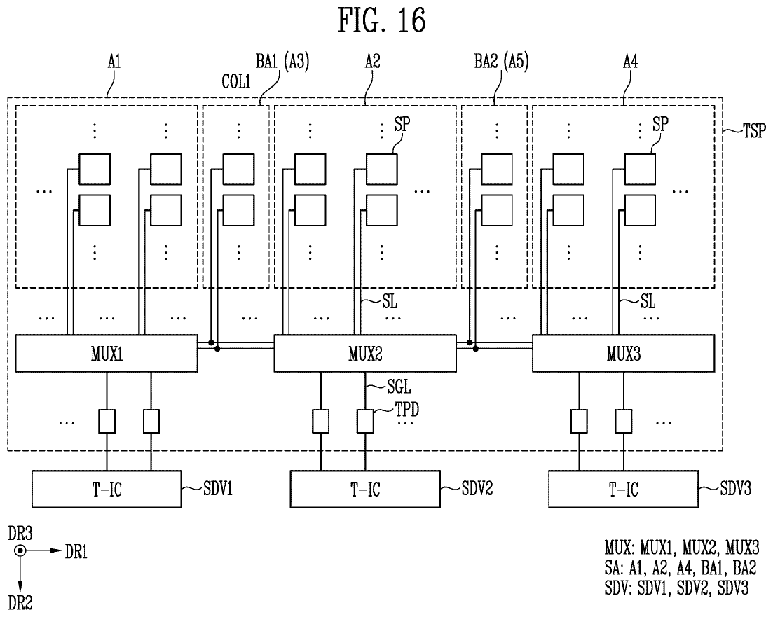

It has been described that the two sensor drivers SDV1 and SDV2 share one boundary area BA with reference to FIGS. 5 and 6, but the present disclosure is not limited thereto. For example, depending on the size of the sensing area SA, the sensing device may include three or more sensor drivers, each of which drives three or more areas within the sensing area SA, and each of which may share a boundary area adjacent to the corresponding area with another sensor driver. It will be described later with reference to FIG. 16.

Referring to FIG. 7, the sensor driver SDV may obtain information on the user touch input UTI by using a self-capacitance method. In an embodiment, the sensing unit TSP or the panel PNL of FIG. 1 may include a capacitance electrode CE. In an embodiment, the capacitance electrode CE may be at least one of the electrodes of the display unit DP of FIG. 1. For example, the capacitance electrode CE may be a cathode electrode of the light-emitting element. However, the capacitance electrode CE is not necessarily limited thereto.

In an embodiment, the sensor driver SDV may charge and discharge a charge to the sensing electrode SP through the signal line SGL, the multiplexer MUX, and the sensing line SL, and detect a capacitance change of the sensing electrode SP to obtain information on the user touch input UTI. The information on the user touch input UTI may include a position of the user touch input UTI or a presence or absence of the user touch input UTI.

For example, a reference voltage (or a driving signal) provided by the sensor driver SDV may be applied to the sensing electrode SP, a self-capacitance Csf may be formed between the sensing electrode SP and the capacitance electrode CE when the user touch input UTI is applied, and the reference voltage may be changed to voltage information (or a sensing signal) having a waveform changed by the self-capacitive. The sensor driver SDV may receive the changed voltage information, and may analyze the changed voltage information to determine the position of the user touch input UTI, whether the user touch input is UTI, and the like.

Referring to FIG. 8, the multiplexer MUX may include a first switch SW1. The first switch SW1 may electrically connect the sensing line SL and the sensor driver SDV.

The sensor driver SDV may include a sensor channel 222. The sensor channel 222 may be configured to receive a sensing signal Vsense from the sensing line SL during a first period in which the first switch SW1 is turned on. The sensor channel 222 may output a voltage signal of a voltage level corresponding to the amount of charge charged to the sensing electrode SP to the output terminal OUT1. For example, the sensor channel 222 may be an integrator.

For example, the sensor channel 222 may include an amplifier AMP, a sensing capacitor Ca, and a reset switch SWr. The amplifier AMP may include a first input terminal IN1 connected to the sensing line SL via the first switch SW1, a second input terminal IN2 receiving a reference signal Vref (or a driving signal), and an output terminal OUT1. For example, the amplifier AMP may be an operational amplifier. For example, the first input terminal IN1 may be an inverting terminal, and the second input terminal IN2 may be a non-inverting terminal.

The sensing capacitor Ca may be electrically connected between the first input terminal IN1 and the output terminal OUT1. The reset switch SWr may be electrically connected between the first input terminal IN1 and the output terminal OUT1. The sensing capacitor Ca and the reset switch SWr may be connected in parallel between the first input terminal IN1 and the output terminal OUT1. In an embodiment, a resistor connected in parallel to the sensing capacitor Ca may be further provided in the sensor channel 222.

The reference signal Vref (or driving signal) may have a square wave. When the reference signal Vref is applied to the second input terminal IN2 of the amplifier AMP, a sensing signal Vsense corresponding to the reference signal VRef may be generated in the sensing line SL (and the sensing electrode SP). The sensing signal Vsense may have a waveform in which the reference signal Vref is RC delayed by the self-capacitance Csf or the like. The self-capacitance Csf may vary depending on the presence or absence of the user touch input UTI (e.g., touch or no touch), and thus the waveform of the sensing signal Vsense may vary.

The sensor driver SDV may further include an analog-to-digital converter 224 (or ADC). The analog-to-digital converter 224 may receive an output signal of the sensor channel 222. The analog-to-digital converter 224 may convert the analog voltage level output by the sensor channel 222 into a digital value and output the digital value. The sensor driver SDV (or processor) may determine the presence or absence of the user touch input UTI, the position of the user touch input UTI, and the like based on the digital value.

As described above, the sensing area SA includes a boundary area BA between the first area A1 and the second area A2, and the first sensor driver SDV1 and the second sensor driver SDV2 may share the sensing electrode SP in the boundary area BA. Based on the sensing signal obtained from the boundary area BA, the first sensor driver SDV1 and the second sensor driver SDV2 may adjust the touch sensitivity, and the touch performance in the boundary area BA may be improved.

Although the first and second multiplexers MUX1 and MUX2 are shown to share the boundary area BA in FIGS. 5 and 6, the present disclosure is not limited thereto. For example, when the multiplexer MUX is not provided, the first and second sensor drivers SDV1 and SDV2 may directly connect and share the sensing electrode SP in the boundary area BA.

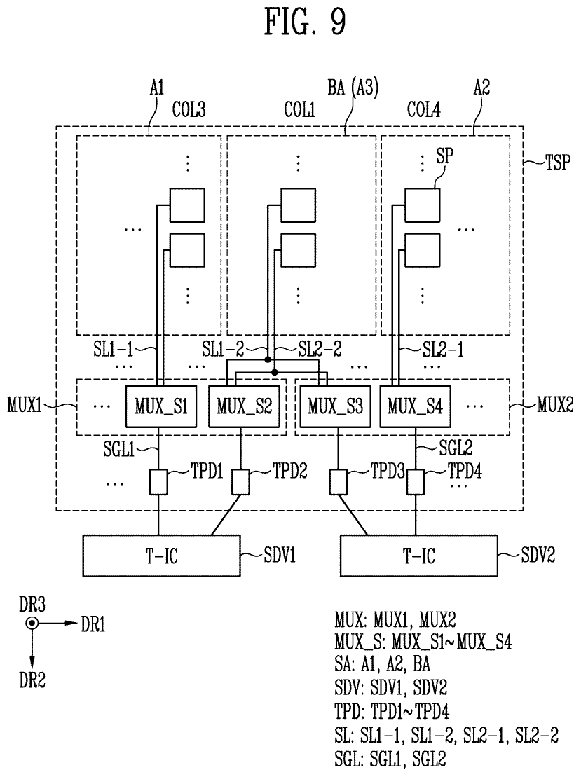

Operations of the multiplexer MUX and the display device (or the sensing device) will be described with reference to FIGS. 9 to 12. For convenience of explanation, contents duplicated with the above-described contents are briefly described or not repeated.

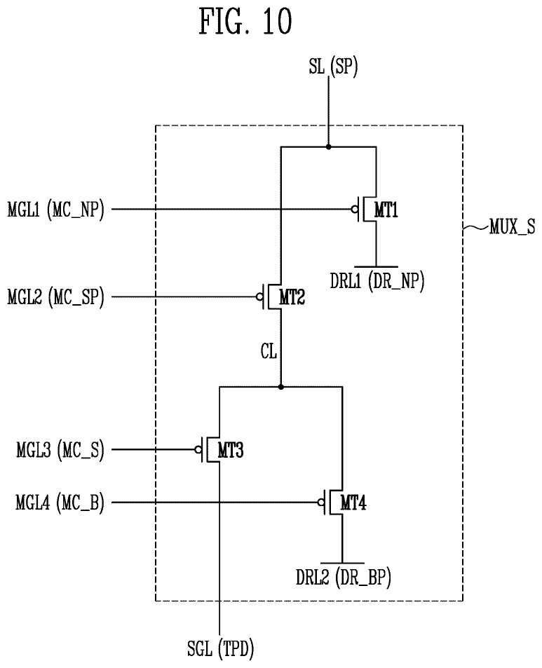

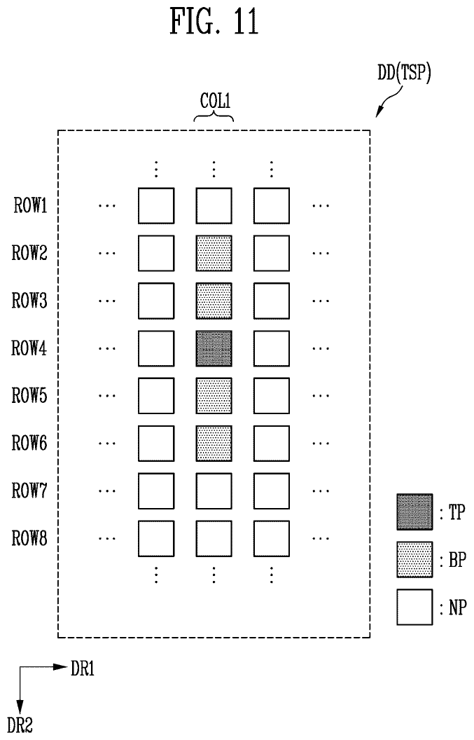

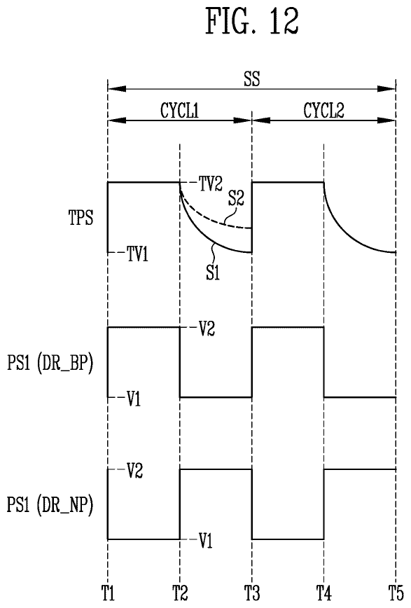

FIG. 9 is a schematic plan view illustrating an embodiment of the sensing device of FIGS. 5 and 6. FIG. 10 is a schematic circuit diagram illustrating an embodiment of a sub-multiplexer included in the sensing device of FIG. 9. FIG. 11 is a plan view illustrating an operation of a sensing device. FIG. 12 is a waveform diagram illustrating an embodiment of a signal applied to the sensing electrode of FIG. 11.

Referring to FIG. 9, the multiplexer MUX may include a sub-multiplexer MUX_S (or a signal selection circuit). The sub-multiplexer MUX_S is provided in units of sensor columns and may selectively connect the sensing electrode SP included in the sensor columns to the corresponding touch sensing pad TPD. For example, the sub-multiplexer MUX_S may be provided for each sensor column or for each two sensor columns.

The first multiplexer MUX1 may include a first sub-multiplexer MUX_S1 and a second sub-multiplexor MUX_S2.

The first sub-multiplexer MUX_S1 may be electrically connected to a sensor column (or the sensing electrodes SP and the sensing lines SL included in the sensor column) in the first area A1. For example, the first sub-multiplexer MUX_S1 may selectively connect the sensing electrodes SP (or the (1-1)th sensing lines SL1-1) in a third sensor column COL3 to a first touch sensing pad TPD1. In an embodiment, the third sensor column COL3 may be closest to the boundary area BA among the sensor columns in the first area A1. The first touch sensing pad TPD1 and a second touch sensing pad TPD2 may be electrically connected to the first sensor driver SDV1.

The second sub-multiplexer MUX_S2 may be electrically connected to a sensor column (or the sensing electrodes SP and the sensing lines SL included in the sensor column) in the boundary area BA. For example, the second sub-multiplexer MUX_S2 may selectively connect the first subset of the sensing electrodes SP (or the (1-2)th sensing lines SL1-2) in the first sensor column COL1 to the second touch sensing pad TPD2. The second sub-multiplexer MUX_S2 is not electrically connected to the first touch sensing pad TPD1. That is, the first subset of the sensing electrodes SP in the boundary area BA is not electrically connected to the first touch sensing pad TPD1.

The second multiplexer MUX2 may include a third sub-multiplexer MUX_S3 and a fourth sub-multiplexor MUX_S4.

The third sub-multiplexer MUX_S3 may be electrically connected to a sensor column (or the second subset of the sensing electrodes SP and the (2-2)th sensing lines SL2-2 included in the sensor column) in the boundary area BA. For example, the third sub-multiplexer MUX_S3 may selectively connect the second subset of the sensing electrodes SP (or the (2-2)th sensing lines SL2-2) in the first sensor column COL1 to a third touch sensing pad TPD3. The third sub-multiplexer MUX_S3 is not connected to a fourth touch sensing pad TPD4. That is, the second subsets of the sensing electrode SP (in the boundary area BA is not connected to the fourth touch sensing pad TPD4. The third touch sensing pad TPD3 and the fourth touch sensing pad TDP4 may be electrically connected to the second sensor driver SDV2.

The fourth sub-multiplexer MUX_S4 may be electrically connected to a sensor column (or the sensing electrodes SP and the (2-1)th sensing lines SL2-1 included in the sensor column) in the second area A2. For example, the fourth sub-multiplexer MUX_S4 may selectively connect the sensing electrodes SP (or the (2-1)th sensing lines SL2-1) in a fourth sensor column COL4 to the fourth touch sensing pad TPD4. In an embodiment, the fourth sensor column COL4 may be closest to the boundary area BA among the sensor columns in the second area A2.

Referring to FIG. 10, the sub-multiplexer MUX_S may selectively connect the sensing line SL (or the sensing electrode SP) to the signal line SGL (or the touch sensing pad TPD), a first driving line DRL1, or a second driving line DRL2. A target pulse signal may be applied to the signal line SGL from the sensor driver SDV illustrated in FIG. 7, a first driving signal DR_NP may be applied to the first driving line DRL1, and a second driving signal DR_BP may be applied to the second driving line DRL2.

The sub-multiplexer MUX_S may include a plurality of mux transistors MT1 to MT4 (or transistors). For example, the mux transistors MT1 to MT4 may include a first mux transistor MT1 (or a first transistor), a second mux transistor MT2 (or a second transistor), a third mux transistor MT3 (or a third transistor), and a fourth mux transistor MT4 (or a fourth transistor).

A first electrode of the first mux transistor MT1 may be electrically connected to the sensing line SL, a second electrode of the first Mux transistor MT1 may be electrically connected to the first driving line DRL1, and a gate electrode of the first mux transistor MT1 may be electrically connected to a first mux gate line MGL1 (or a first gate line). The first mux transistor MT1 may be turned on when the first gate signal MC_NP is applied from the first mux gate line MGL1 to electrically connect the sensing line SL and the first driving line DRL1.

A first electrode of the second mux transistor MT2 may be electrically connected to the sensing line SL, a second electrode of the second Mux transistor MT2 may be electrically connected to a connection line CL, and a gate electrode of the second mux transistor MT2 may be electrically connected to a second mux gate line MGL2 (or a second gate line). The second mux transistor MT2 may be turned on when the second gate signal MC_SP is applied from the second mux gate line MGL2 to electrically connect the sensing line SL and the connection line CL.

A first electrode of the third mux transistor MT3 may be electrically connected to the connection line CL, a second electrode of the third Mux transistor MT3 may be electrically connected to the signal line SGL, and a gate electrode of the third mux transistor MT3 may be electrically connected to a third mux gate line MGL3 (or a third gate line). The third mux transistor MT3 may be turned on when the third gate signal MC_S is applied from the third mux gate line MGL3 to electrically connect the connection line CL and the signal line SGL.

A first electrode of the fourth mux transistor MT4 may be electrically connected to the connection line CL, a second electrode of the fourth Mux transistor MT4 may be electrically connected to the second driving line DRL2, and a gate electrode of the fourth mux transistor MT4 may be electrically connected to a fourth mux gate line MGL4 (or a fourth gate line). The fourth mux transistor MT4 may be turned on when the fourth gate signal MC_B is applied from the fourth mux gate line MGL4 to electrically connect the connection line CL and the second driving line DRL2.

When the second mux transistor MT2 and the third mux transistor MT3 are turned on, the sensing line SL (or the sensing electrode SP) may be electrically connected to the signal line SGL (or the touch sensing pad TPD).

When the second mux transistor MT2 and the fourth mux transistor MT4 are turned on, the sensing line SL (or the sensing electrode SP) may be electrically connected to the second driving line DRL2, and the second driving signal DR_BP may be applied to the sensing electrode SP.

When the first mux transistor MT1 is turned on, the sensing line SL (or the sensing electrode SP) may be electrically connected to the first driving line DRL1, and the first driving signal DR_NP may be applied to the sensing electrode SP.

The target pulse signal may be a sensing driving signal for sensing the user touch input UTI at a position where the sensing electrode SP (or a target sensing electrode TP (see FIG. 11)) electrically connected to the sensing line SL is disposed. The first driving signal DR_NP may be a sensing auxiliary signal applied to a corresponding sensing electrode SP (or a non-sensing sensing electrode NP (see FIG. 11)) when the user touch input UTI is not sensed at and around a position where the sensing electrode SP electrically connected to the sensing line SL is disposed. The second driving signal DR_BP may be a sensing auxiliary signal for determining information about the user touch input UTI when sensing the user touch input UTI using another sensing electrode SP (or an adjacent sensing electrode BP (see FIG. 11)) in an area adjacent to a position where the sensing electrode SP electrically connected to the sensing line SL is disposed.

Referring to FIG. 11, with respect to the first sensor column COL1 included in the display device DD (or the sensing unit TSP), a sensor electrode located in a fourth row ROW4 may be selected as the target sensing electrode TP connected to the sensor driver SDV (see FIG. 7). In this case, a sensor electrode located in a row adjacent to the fourth row ROW4 may be the adjacent sensing electrode BP. For example, the sensor electrode located in a second row ROW2, a third row ROW3, a fifth row ROW5, and a sixth row ROW6 may be selected as the adjacent sensing electrode BP. At least one of the remaining sensor electrodes except for the sensor electrodes located in the second to sixth rows ROW2 to ROW6 may be a non-sensing electrode NP. For example, a sensor electrode located in a first row ROW1, a seventh row ROW7, or an eighth row ROW8 may be selected as the non-sensing electrode NP.

Referring to FIGS. 7 and 10 to 12, the target pulse signal TPS may be applied to the target sensing electrode TP from the sensor driver SDV. A first pulse signal PS1 may be applied to the adjacent sensing electrode BP. The first pulse signal PS1 may be a second driving signal DR_BP of the second driving line DRL2. A second pulse signal PS2 may be applied to the non-sensing electrode NP. The second pulse signal PS2 may be a first driving signal DR_NP of the first driving line DRL1. The first pulse signal PS1 may have the same phase as the target pulse signal TPS, and the second pulse signal PS2 may have a phase opposite to the target pulse signal TPS.

At a first time point T1, the target pulse signal TPS applied to the target sensing electrode TP may transition from a first target voltage level TV1 to a second target voltage level TV2.

At a second time point T2, the target pulse signal TPS may be gradually reduced from the second target voltage level TV2 to the first target voltage level TV1. A slope of the voltage level of the target pulse signal TPS may change according to a user's touch. For example, when the user's touch is not adjacent to the target sensing electrode TP, the voltage level of the target pulse signal TPS may have a first slop S1. For example, when the user's touch is adjacent to the target sensing electrode TP, the voltage level of the target pulse signal TPS may have a second slop S2. The sensor driver SDV (or processor) may sense a user's touch depending on whether the target pulse signal TPS has the first slop S1 or the second slop S2.

At the first time point T1, the first pulse signal PS1 applied to the adjacent sensing electrode BP may transition from the first voltage level V1 to the second voltage level V2. At the same time, the second pulse signal PS2 applied to the non-sensing electrode NP may transition from the second voltage level V2 to the first voltage level V1.

At the second time point T2, the first pulse signal PS1 may transition from the second voltage level V2 to the first voltage level V1. At the same time, the second pulse signal PS2 may transition from the first voltage level V1 to the second voltage level V2.

At a third time point T3, the first pulse signal PS1 may again transition from the first voltage level V1 to the second voltage level V2. At the same time, the second pulse signal PS2 may again transition from the second voltage level V2 to the first voltage level V1.

Here, a time between the first and third time points T1 and T3 may be defined as a first period CYCL1. Operations at the third time point T3, a fourth time point T4, and a fifth time point T5 may be described as well as operations at the first time point T1, the second time point T2, and the third time point, respectively. At the fifth time point T5, a sensing period SS for the target sensing electrode TP ends, and the time between the third and fifth times T3 and T5 may be defined as a second period CYCL2 following the first period CYCL1. As such, the sensing period SS may include one or more periods CYCL1 and CYCL2 to sense a user's touch through the target sensing electrode TP.

The first pulse signal PS1 applied to the adjacent sensing electrode BP may have a form in which a plurality of square waves are repeated during the sensing period SS, and the second pulse signal PS2 applied to the non-sensing electrode NP may have a form in which a plurality the square waves having a phase opposite to that of the first pulse signal PS1, are repeated. The first pulse signal PS1 and the second pulse signal PS2 may have the same frequency as the target pulse signal TPS. When the second pulse signal PS2 is applied to the non-sensing electrode NP, EMI (Electro Magnetic Interference) by the first pulse signal PS1 is reduced, and touch performance may be improved.

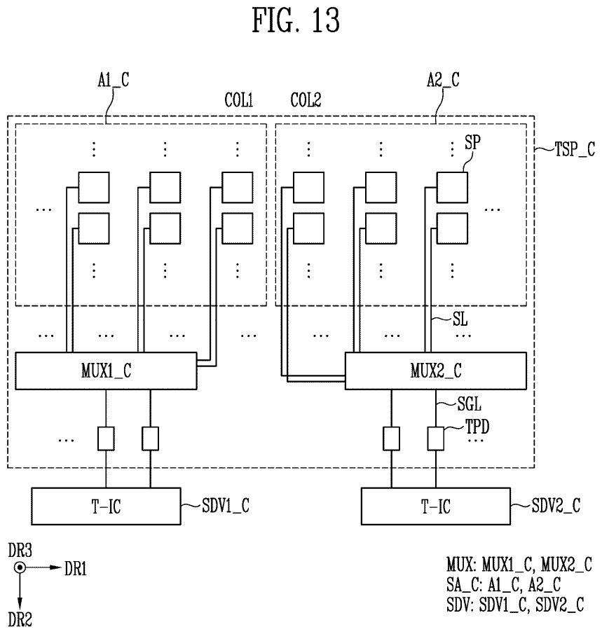

FIG. 13 is a schematic plan view illustrating a sensing device according to a comparative example. FIG. 14 is a diagram illustrating an embodiment of a sensing signal acquired by the sensing device of FIG. 13 and a sensing signal acquired from the sensing device of FIG. 5. FIG. 15 is a waveform diagram illustrating an embodiment of a sensing signal acquired by the sensing device of FIG. 5. For convenience of explanation, contents duplicated with the above-described contents are briefly described or not repeated.

Referring to FIG. 13, the sensing area SA_C may include a first area A1_C and a second area A2_C. The first area A1_C and the second area A2_C may be adjacent to each other in the first direction DR1. The sensing area SA_C does not include the boundary area BA of FIG. 6.

A first sensor driver SDV1_C may be electrically connected to the sensing electrode SP in the first area A1_C through a first multiplexer MUX1_C. A second sensor driver SDV2_C may be electrically connected to the sensing electrode SP in the second area A2_C through a second multiplexer MUX2_C.

There is no area (or sensing electrode SP) shared by the first sensor driver SDV1_C and the second sensor driver SDV2_C, and the first sensor driver SDV1_C and the second sensor driver SDV2_C may independently drive the first area A1_C and second area A2_C.

Referring to FIG. 14, a fourth curve CURVE4 represents sensing values or sensing data obtained from sensing electrodes included in a row by the first and second sensor drivers SDV1_C and SDV2_C of FIG. 13. For example, each of the sensing values may be a value output from the analog-to-digital converter 224 of FIG. 8. A length of the sensing line SL for the first area A1_C and a length of the sensing line SL for the second area A2_C may be different depending on the structure of the display device or process variation, or the capacitance formed in the sensing electrode SP or the sensing line SL may be different between a first area A1_C and a second area A2_C. For this reason, the sensing value (and touch sensitivity) obtained in the first area A1_C may be different from the sensing value (and touch sensitivity) acquired in the second area A2_C. For example, the sensing value obtained in the second area A2_C may be higher than the sensing value obtained from the first area A1_C, and a difference between the sensing value obtained from the first sensor column COL1 and the sensing value obtained from the second sensor column COL2 adjacent to each other may be large.

The first sensor driver SDV1_C and the second sensor driver SDV2_C may adjust the sensing value or touch sensitivity, for example, a gain/offset, sampling time, reference signal Vref, or the like of the analog-to-digital converter 224 of FIG. 8. However, because the first sensor driver SDV1_C and the second sensor driver SDV2_C are driven independently of each other, it is difficult to objectively compare the touch sensitivity of the first sensor driver SDV1_C with the touch sensitivity of a second sensor driver SDV2_C, and a decrease in touch performance may occur between the first area A1_C and a second area A2_C. For example, when a user's touch occurs between the first area A1_C and the second area A2_C, a touch input may not be properly sensed due to a difference in touch sensitivity between the first area (A1_C) and the second area (A2_C). For example, in an area with high touch sensitivity, a change in fine capacitance is also sensed, so a glove touch (i.e., a touch with a small change in self-capacitance while the user is wearing a glove) is sensed, but noise may be determined as a touch (that is, a ghost touch occurs). The glove touch may not be sensed in an area with low touch sensitivity.

Accordingly, the first sensor driver SDV1 and the second sensor driver SDV2 according to the embodiments of FIGS. 5 and 6 may share the boundary area BA between the first area A1 and the second area A2, and may objectively adjust the touch sensitivity based on the sensing value obtained from the boundary area BA.

Referring to FIGS. 14 and 15, the first curve CURVE1 represents sensing values or sensing data obtained from sensing electrodes included in a row by the first sensor driver SDV1 of FIG. 5. The second curve CURVE2 represents sensing values or sensing data obtained from sensing electrodes included in the row by the second sensor driver SDV2 of FIG. 5.

The first sensor driver SDV1 may obtain one sensing value (or sensing signal) for each sensing electrode SP in the first area A1 and the boundary area BA. The first sensor driver SDV1 may obtain first sensing values SV1 for the first and second sensor columns COL1 and COL2 in the boundary area BA. The second sensor driver SDV2 may obtain one sensing value for each sensing electrode SP in the boundary area BA and the second area A2. The second sensor driver SDV2 may obtain second sensing values SV2 for the first and second sensor columns COL1 and COL2 in the boundary area BA. That is, two sensing values SV1 and SV2 may be obtained for the boundary area BA. By comparing the first sensing values SV1 and the second sensing values SV2, the first and second sensor drivers SDV1 and SDV2 may adjust touch sensitivity. For example, like a third CURVE3, the first and second sensor drivers SDV1 and SDV2 may adjust the sensing values or touch sensitivity for the boundary area BA to be the same or similar to each other. Accordingly, touch performance with respect to the boundary area BA may be improved.

Referring to FIGS. 5 and 15, during a sensing frame period, each of the first and second sensor drivers SDV1 and SDV2 may sequentially drive or scan a sensor column (or a sensing electrode SP) along the first direction DR1, and sequentially obtain a sensing value (or a sensing signal) along the first directions DR1. The sixth time point T6 may be a start time point of a sensing frame period, and the seventh time point T7 may be an end time point of the sensing frame period. For example, the first sensor driver SDV1 may obtain the first sensing values SV1 for the first and second sensor columns COL1 and COL2 in the boundary area BA at the seventh time point T7, and the second sensor driver SDV2 may obtain the second sensing values SV2 for the first and the second sensor columns COL1 and COL2 in the boundary area BA at the sixth time point T6. That is, the first sensor driver SDV1 and the second sensor driver SDV2 may obtain sensing values for the boundary area BA at different and non-overlapping time points. For reference, when the first and second sensor drivers SDV1 and SDV2 scan the sensing electrode SP at the same time, a driving signal is applied to the sensing electrode SP from each of the first and second sensors drivers SDV1 and SDV2, and an error may occur.

As described above, the first sensor driver SDV1 and the second sensor driver SDV2 share the boundary area BA between the first area A1 and the second area A2, and may objectively adjust the touch sensitivity based on the sensing value obtained from the boundary area BA. Accordingly, touch performance for the boundary area BA may be improved.

FIG. 16 is a schematic plan view illustrating a sensing device according to embodiments.

Referring to FIGS. 5, 6, and 16, the sensing device of FIG. 16 may be substantially the same as or similar to the sensing device of FIG. 5 or 6, except for a fourth area A4, a second boundary area BA2, a third multiplexer MUX3, and a third sensor driver SDV3. Therefore, redundant descriptions are omitted.

The sensing area SA may further include the fourth area A4 and the second boundary area BA2 (or a second shared area, a fifth area A5). The first boundary area BA1 may be substantially the same as or similar to the boundary area BA of FIG. 6 (or FIG. 5). The fourth area A4 may be spaced apart in the first direction DR1 from the second area A2, and the second boundary area BA2 may be located between the second area A2 and the fourth area A4. The fourth area A4 and the second boundary area BA2 (or configurations included in the fourth area A4 and the second boundary area BA2) may be substantially the same as or similar to the second area A2 and the first boundary area BA1, respectively, except for positions.

The sensor driver SDV may further include the third sensor driver SDV3. The third sensor driver SDV3 may be implemented as an integrated circuit. The third sensor driver SDV3 may be electrically connected to the sensing electrode SP in the fourth area A4 through the sensing line SL.

Each of the second sensor driver SDV2 and the third sensor driver SDV3 may be electrically connected to the sensing electrode SP in the second boundary area BA2 through the sensing line SL. That is, the second sensor driver SDV2 and the third sensor driver SDV3 may share the sensing electrode SP in the second boundary area BA2. The second sensor driver SDV2 and the third sensor driver SDV3 may adjust the touch sensitivity based on the sensing signal acquired from the second boundary area BA2. In this case, a difference in touch sensitivity between the second area A2 and the fourth area A4 may be reduced, and touch performance for the second boundary area BA2 may be improved.

The multiplexer MUX may further include the third multiplexer MUX3. The third multiplexer MUX3 may be electrically connected between the sensing electrode SP in the fourth area A4 and the third sensor driver SDV3. In addition, the third multiplexer MUX3 may be electrically connected to the sensing electrode SP in the second boundary area BA2. The third multiplexer MUX3 may selectively connect the sensing electrode SP (or the sensing line SL connected to the sensing electrode SP) in the fourth area A4 and the second boundary area BA2 to the signal line SGL (or the third sensor driver SDV3 connected to the signal line SGL).

In addition, the second multiplexer MUX2 may be electrically connected to the sensing electrode SP in the second boundary area BA2. That is, the second and third multiplexers MUX2 and MUX3 may share the sensing electrode SP in the second boundary area BA2.

As described above, the sensing area SA may include the first, second, and fourth areas A1, A2 and A4 and the first and second boundary areas BA1 and BA2 between the first, second, and fourth areas A1, A2 and A4, the first and second sensor drivers SDV1 and SDV2 may share the sensing electrode SP in the first boundary area BA1, and the second and third sensor drivers SDV2 and SDV3 may share the sensing electrodes SP in the second boundary area BA2. The first sensor driver SDV1 and the second sensor driver SDV2 may adjust the touch sensitivity based on the sensing signal obtained from the first boundary area BA1, and the second sensor driver SDV2 and the third sensor driver SDV3 may adjust the touch sensitivity based on the sensing signal obtained from the second boundary area BA2. Accordingly, touch performance in the boundary areas BA1 and BA2 may be improved.

Although it has been described with reference to FIG. 16 that the sensing area SA is divided into three areas A1, A2, and A4 in the first direction DR1, and the three sensor drivers SDV1 to SDV3 (and the three multiplexers MUX1 to MUX3) respectively responsible for (or having jurisdiction over) the areas A1, A2 and A4 share an adjacent boundary area, the arrangement/number of areas (and boundary areas) or the relationship between configurations (e.g., connection relationship between the areas (and boundary areas), the multiplexers, and the sensor drivers) is not limited thereto. Depending on the structure or size of the panel PNL (see FIG. 1) (or the sensing unit TSP (see FIG. 3)), the arrangement/number of areas (and boundary areas) or the relationship between the configurations may be variously configured.

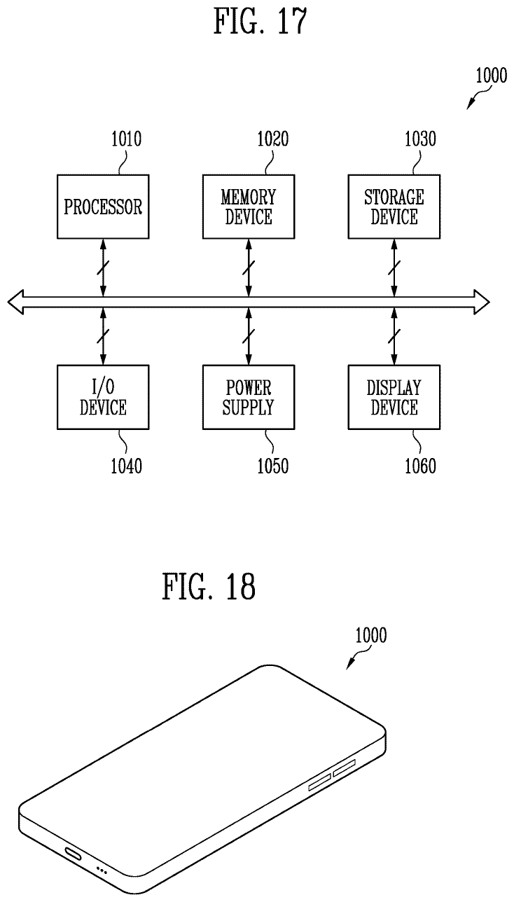

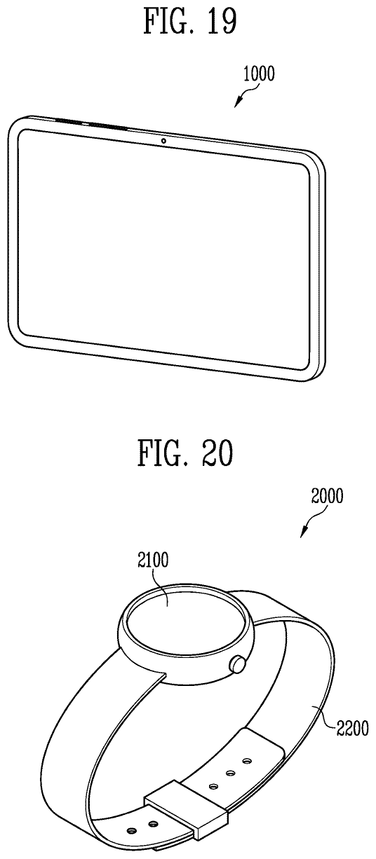

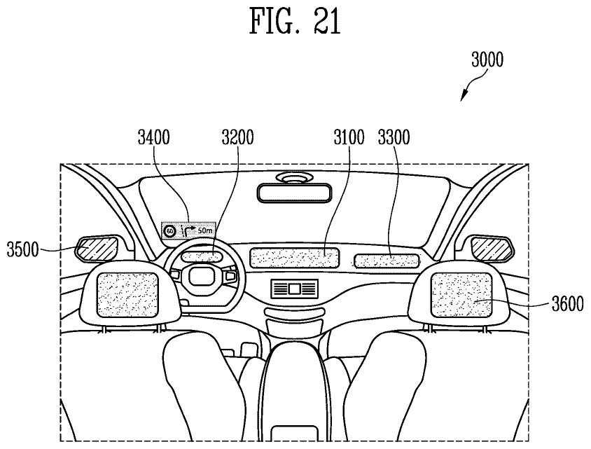

FIG. 17 is a schematic block diagram illustrating an electronic device according to embodiments. FIG. 18 is a schematic diagram illustrating an example in which the electronic device of FIG. 17 is implemented as a smartphone. FIG. 19 is a schematic diagram illustrating an example in which the electronic device of FIG. 17 is implemented as a tablet PC. FIG. 20 is a schematic diagram illustrating an example in which the electronic device of FIG. 17 is implemented as a smart watch. FIG. 21 is a schematic diagram illustrating an example in which the electronic device of FIG. 17 is implemented as an automobile display system.

Referring to FIGS. 17 to 21, the electronic device 1000 may include a processor 1010, a memory device 1020, a storage device 1030, an input/output device 1040, a power supply 1050, and a display device 1060. The display device 1060 may be the display device DD described above. In addition, the electronic device 1000 may further include various ports capable of communicating with a video card, a sound card, a memory card, a USB device, or the like, or communicating with other systems.

The processor 1010 may perform some calculations or tasks. In an embodiment, the processor 1010 may be a microprocessor, a central processing unit, an application processor, or the like. The function or functions of the processor 1010 may be performed by one or more processors. The processor 1010 may be coupled to other components via an address bus, a control bus, a data bus, and the like. In an embodiment, the processor 1010 may also be connected to an extension bus, such as a Peripheral Component Interconnect (PCI) bus. In an embodiment, the processor 1010 may provide input image data to the display device 1060, and accordingly, the display device 1060 may display an image based on the input image data provided from the processor 1010.

In an embodiment, the processor 1010 may receive a sensing signal (or sensing data) from the first and second sensor drivers SDV1 and SDV2 of FIGS. 5 and 6, and sense a user touch input based on the sensing signal. In an embodiment, the processor 1010 may control the first and second sensor drivers SDV1 and SDV2 to adjust the touch sensitivity based on the sensing signal from the boundary area BA.

The memory device 1020 may store data necessary for operation of the electronic device 1000. For example, the memory device 1020 may include a non-volatile memory device such as an Erasable Programmable Read-Only Memory (EPROM) device, an Electrically Erasable programmable Read-only Memory (EEPROM) device, a flash memory device, a Phase Change Random Access Memory (PRAM) device, a Resistance Random Access memory (RRAM) device, an Nano Floating Gate Memory (NFGM) device, a Polymer Random Access Memory (PoRAM) device, a Magnetic Random Access Memory (MRAM), a Ferroelectric Random Access Memory (FRAM) device, or the like, or a volatile memory device such as a Dynamic Random Access Memory (DRAM) device, a Static Random access memory (SRAM) device, mobile DRAM device, and the like.

The storage device 1030 may include a solid state drive (SSD), a hard disk drive (HDD), a CD-ROM, and the like.

The input/output device 1040 may include input means such as a keyboard, keypad, touchpad, touchscreen, mouse, and the like, and output means such as a speaker, a printer, and the like. In an embodiment, the display device 1060 may be included in the input/output device 1040.

The power supply 1050 may supply power required for the operation of the electronic device 1000. For example, the power supply 1050 may be a power management integrated circuit (PMIC). In an embodiment, the power supply 1050 may supply power to the display device 1060.

The display device 1060 may display an image corresponding to visual information of the electronic device 1000. The display device 1060 may be connected to other components via the buses or other communication links.

The electronic device 1000 may include a computing system that provides an image display function, such as a smart watch, a mobile phone, a smart phone, a portable computer, a tablet personal computer (PC), a watch phone, an automobile display, a smart glass, a portable multimedia player (PMP), a navigation, an ultra mobile personal computer (UMPC), and the like. In addition, the electronic device 1000 may include at least one of a head mounted display (HMD), a virtual reality (VR) device, a mixed reality (MR) device, and an augmented reality (AR) device.

In an embodiment, as shown in FIG. 18, the electronic device 1000 may be implemented as a smartphone. In an embodiment, as shown in FIG. 19, the electronic device 1000 may be implemented as a tablet PC.

In an embodiment, as shown in FIG. 20, the electronic device 1000 may be applied to the smart watch 2000. The smart watch 2000 may be a wearable electronic device. For example, the smart watch 2000 may have a structure in which a strap portion 2200 is mounted on a user's wrist. Here, the display device 1060 may be applied to a display unit 2100, and image data including time information may be provided to the user.

In an embodiment, as shown in FIG. 21, the electronic device 1000 may be applied to an automobile display system 3000. Here, the automobile display system 3000 may include a computing system provided inside or outside a vehicle to provide image data.

For example, the electronic device 1000 may be applied to at least one of an infortainment panel 3100, a cluster 3200, a co-driver display 3300, a head-up display 3400, a side mirror display 3500, and a rear seat display 3600 provided in the vehicle.

While the present disclosure has been described with reference to embodiments thereof, it will be apparent to those of ordinary skill in the art that various changes and modifications may be made thereto without departing from the scope and spirit of the present disclosure as set forth in the following claims.

What is claimed is:

1. A sensing device comprising:
a sensor panel including sensors arranged in a matrix form in a sensing area and sensing lines electrically connected one-to-one to the sensors, wherein the sensing area includes a first area, a second area, and a third area between the first area and the second area, wherein the sensing lines include (1-1)th sensing lines, (1-2)th sensing lines, (2-1)th sensing lines, and (2-2)th sensing lines;
a first sensor driver electrically connected to the sensors in the first area through the (1-1)th sensing lines; and
a second sensor driver electrically connected to the sensors in the second area through the (2-1)th sensing lines,
wherein the first sensor driver is electrically connected to a first subset of the sensors in the third area through the (1-2)th sensing lines, and
wherein the second sensor driver is electrically connected to a second subset of the sensors in the third area through the (2-2)th sensing lines.

2. The sensing device of claim 1, wherein the first sensor driver is electrically disconnected from the sensors in the second area, and
wherein the second sensor driver is electrically disconnected from the sensors in the first area.

3. The sensing device of claim 1, wherein the first area and the second area are spaced apart from each other in a first direction,
wherein the third area includes at least one sensor column, and
wherein a sensor column includes the sensors arranged along a second direction intersecting the first direction.

4. The sensing device of claim 3, wherein the third area includes two sensor columns.

5. The sensing device of claim 3, wherein the third area includes one sensor column.

6. The sensing device of claim 1, further comprising:
a first multiplexer electrically connected between the sensors in the first area and the first sensor driver; and
a second multiplexer electrically connected between the sensors in the second area and the second sensor driver,
wherein the first multiplexer and the second multiplexer are electrically connected to the first subset of the sensors and the second subset of the sensors, respectively, in the third area.

7. The sensing device of claim 6, wherein the first multiplexer is electrically connected to the first sensor driver through pads,
wherein the first multiplexer selectively connects the first subset of the sensors in the third area to a pad among the pads, and
wherein the sensors in the first area are not electrically connected to the pad.

8. The sensing device of claim 7, wherein the first multiplexer includes:
a first transistor electrically connected between a sensing line among the sensing lines and a first driving line;
a second transistor electrically connected between the sensing line and a connection line;
a third transistor electrically connected between the connection line and the pad among the pads; and
a fourth transistor electrically connected between the connection line and a second driving line.

9. The sensing device of claim 8, wherein the one pad is provided with a target pulse signal,
wherein the first driving line is provided with a first driving signal having a phase opposite to the target pulse signal, and
wherein the second driving line is provided with a second driving signal having a same phase as the target pulse signal.

10. The sensing device of claim 1, wherein the first sensor driver and the second sensor driver obtain one sensing signal for each of the sensors in the first area and the second area, and obtain two sensing signals for each of the sensor in the third area.

11. The sensing device of claim 10, wherein the first sensor driver and the second sensor driver sense a touch input based on sensing signals received from the sensors, and
wherein the first sensor driver and the second sensor driver adjust touch sensitivity based on the sensing signals obtained from the sensors in the third area.

12. The sensing device of claim 10, wherein the first area and the second area are spaced apart from each other in a first direction,
wherein each of the first sensor driver and the second sensor driver sequentially obtains the sensing signal from the sensors along the first direction, and
wherein a time point at which the first sensor driver obtains the sensing signal for the sensors in the third area and a time point at which the second sensor driver obtains the sensing signal for the sensors in the second area are different from each other and do not overlap each other.

13. A sensor panel comprising:
a sensing area including a first area, a second area, and a third area between the first area and the second area;
sensors arranged in matrix form in the sensing area;
sensing lines electrically connected one-to-one to the sensors, wherein the sensing lines include (1-1)th sensing lines, (1-2)th sensing lines, (2-1)th sensing lines, and (2-2)th sensing lines;
a first multiplexer electrically connected to the sensors in the first area through the (1-1)th sensing lines; and
a second multiplexer electrically connected to the sensors in the second area through the (2-1)th sensing lines,
wherein the first sensor driver is electrically connected to a first subset of the sensors in the third area through the (1-2)th sensing lines, and
wherein the second sensor driver is electrically connected to a second subset of the sensors in the third area through the (2-2)th sensing lines.

14. The sensor panel of claim 13, wherein the first multiplexer is electrically disconnected from the sensors in the second area, and
wherein the second multiplexer is electrically disconnected from the sensors in the first area.

15. The sensor panel of claim 13, wherein the first area and the second area are spaced apart from each other in a first direction,
wherein the third area includes at least one sensor column, and
wherein a sensor column includes the sensors arranged along a second direction intersecting the first direction.

16. The sensor panel of claim 15, wherein the third area includes two sensor columns.

17. The sensor panel of claim 15, wherein the third area includes one sensor column.

18. The sensor panel of claim 13, wherein the first multiplexer is electrically connected to pads,
wherein the first multiplexer selectively connects the first subset of the sensors in the third area to a pad among the pads, and
wherein the sensors in the first area are not electrically connected to the pad.

19. The sensor panel of claim 18, wherein the first multiplexer includes:
a first transistor electrically connected between a sensing line among the sensing lines and a first driving line;
a second transistor electrically connected between the sensing line and a connection line;
a third transistor electrically connected between the connection line and the pad among the pads; and
a fourth transistor electrically connected between the connection line and a second driving line.

20. An electronic device comprising:
one or more processors configured to provide input image data;
a display device configured to display an image based on the input image data; and
a power supply configured to supply power to the display device,
wherein the display device includes:
a display unit including a base layer and a light-emitting element disposed on the base layer;
a sensing unit including sensors and sensing lines, wherein the sensors are disposed on the display unit and arranged in a matrix form in a sensing area, the sensing lines are electrically connected to the sensors one-to-one, and the sensing area includes a first area, a second area, and a third area between the first area and the second area, wherein the sensing lines include (1-1)th sensing lines, (1-2)th sensing lines, (2-1)th sensing lines, and (2-2)th sensing lines;
a first sensor driver electrically connected to the sensors in the first area through the (1-1)th sensing lines; and
a second sensor driver electrically connected to the sensors in the second area through the (2-1)th sensing lines,
wherein the first sensor driver is electrically connected to a first subset of the sensors in the third area through the (1-2)th sensing lines, and
wherein the second sensor driver is electrically connected to a second subset of the sensors in the third area through the (2-2)th sensing lines.
